(19) United States
(12) Patent Application Publication
(10) Pub. No.: US 2015/0212189 A1
(43) Pub. Date: Jul. 30, 2015

(54) DEVICE AND METHOD FOR DETECTING AT LEAST ONE STRUCTURE-BORNE SOUND SIGNAL

(71) Applicant: Hella KGaA Hueck & Co., Lippstadt (DE)

(72) Inventors: Andre KNEIFEL, Bremen (DE); Klaas Hauke BAUMGARTEL, Delmenhorst (DE); Karl-Ludwig KRIEGER, Brinkum (DE)

(21) Appl. No.: 14/610,636

(22) Filed: Jan. 30, 2015

(30) Foreign Application Priority Data
Jan. 30, 2014 (DE) 102014001258.1

(51) Int. Cl. G01S 3/80; G01S 5/20

(52) U.S. Cl. CPC G01S 3/80; G01S 5/20

(57) ABSTRACT

A method is provided for detecting at least one structure-borne sound signal, in particular for detecting at least one damage event and/or at least one contact event. On a motor vehicle with a sensor, provision is made for a site of impact of the damage event and/or contact event to be determined by recording at least one measurement signal at a single sensor having a single structural unit, and for separately determining the distance between the sensor and the site of impact and the direction from which the structure-borne sound signal hits the single sensor. A device is also provided for detecting at least one structure-borne sound signal, in particular a structure-borne sound signal influenced by a damage event and/or contact event, with at least one sensor. The sensor has at least one storage device and at least one signal-transferring connection with at least one evaluation device.

### BACKGROUND OF THE INVENTION

1. Field of the Invention

The invention relates to a method for detecting at least one structure-borne sound signal, in particular for detecting at least one damage event and/or at least one contact event, in particular on a motor vehicle, with a sensor means. Further the invention relates to a device for detecting at least one structure-borne sound signal, in particular a structure-borne sound signal influenced by a damage event and/or a contact event, with at least one sensor means, wherein the sensor means comprises at least one signal-transferring connection with at least one storage means. In addition the invention relates to a vehicle, in particular a motor vehicle with an above-mentioned device.

2. Brief Discussion of the Related Art

Methods and devices for detecting damage events are known and are often used in the motor vehicle field. For example the DE 100 34 524 A1 has disclosed a method and a device for detecting an accident-related deformation of at least one component of a motor vehicle. Here a structure-borne frequency spectrum is recorded and a corresponding sensor signal is forwarded from a sensor means to an evaluation means. The components of the motor vehicle are repeatedly stimulated with defined frequency pulses, with the resulting structure-borne frequency spectra being recorded by the device. If significant changes are found in a structure-borne frequency spectrum when compared to a previously detected structure-borne frequency spectrum, these are used to draw the conclusion that an accident-related deformation of the respective component has occurred. This method can be used to monitor one or more components of a motor vehicle. What is not possible with this method is a determination, at which position of the respective component the impact of the damage event has occurred.

### SUMMARY OF THE INVENTION

In order to obtain maximum accurate documentation of a damage event, it is of great importance to accurately locate the site of impact of the damage event. For example, it is thus possible, while the vehicle is travelling, to determine the exact position of a rock fall or point of contact with another vehicle on the outer shell of the vehicle. This information can furnish important hints for reconstructing the course of an accident, for example. Furthermore such a device should be able to be manufactured as cost-effectively as possible.

The invention is based on the requirement to propose a method and a device with which it is possible to determine the site of a damage event and/or a contact event on e.g. a motor vehicle, and where assembly costs are not increased through extensive cabling.

The solution to this requirement is effected by a method with the characteristics of patent claim 1, a device with the characteristics of patent claim 9 and a vehicle with the characteristics of patent claim 14.

Further developments and advantageous implementations are given in the respective sub-claims.

The method for recording at least one structure-borne sound signal, in particular for detecting at least one damage event and/or at least one contact event, in particular on a motor vehicle, with a sensor means is characterised according to the invention in that a site of impact of the damage event and/or the contact event is determined by at least one measurement signal being recorded at a single sensor means consisting of a single structural unit, and by the separate determination of, on the one hand, the distance between the sensor means and the site of impact and, on the other, the direction from which the structure-borne sound signal hits the single sensor means.

Preferably the sensor means is mounted to the inside of the outer shell of a motor vehicle. Due to the fact that the sensor means consists of a single structural unit, a relatively simple assembly is ensured. Preferably the sensor means is mounted centrally to the inside of an areal region of the outer shell of a motor vehicle, e.g. to a side door. To locate the site of impact, i.e. the location, at which a force such as a rock fall acts upon the outer shell of the motor vehicle, the distance is determined between the sensor means and the site of impact as well as the direction from which the signal created at the site of impact hits the sensor means. The signal is a structure-borne sound signal which e.g. propagates in the form of a bending wave in the areal region of the structural part. The advantage of using a single sensor means consisting of a single structural unit as compared to several sensor means distributed across the areal region consists in that there is now no need for having to synchronise the individual sensor means. Synchronising is necessary when using several sensor means, e.g. for determining signal differences. Furthermore there is no need for any communication between different sensor means so that possible method steps and communication devices can be omitted. Preferably the site of impact, i.e. the source of the structure-borne sound signal, is determined by calculating the polar coordinates in dependence of the position of the sensor means. Alternatively it is possible to calculate the site of impact in Cartesian coordinates or other coordinate systems.

In a preferred embodiment of the method the measurement signals of at least two, in particular three sensor elements of the sensor means are recorded. For example, a structure-borne sound signal caused by a damage event may be recorded at each of the three sensor elements independently of another. The distance between the sensor means and the site of impact can be calculated via the propagation speed of the bending wave of the structure-borne sound signal. To this end the effect of dispersion can be utilised, i.e. the dependency of the propagation speed from the wave of the respective frequency. The angle at which the wave hits the sensor means can be calculated by means of the runtime differences between the three sensor elements and indicated, for example, in polar coordinates the reference point of which may e.g. be the position of the sensor means.

In a preferred embodiment of the method a Fourier transform, in particular a short-time Fourier transform, is applied respectively to at least one portion of the measurement signal, thus allowing determination of the phases of individual frequency portions, determination of the phase difference for at least two frequency portions, calculation of the runtime of the structure-borne sound signal from the phase difference and determination of the distance between the sensor element and the site of impact from the runtime of the structure-borne sound signal. Preferably the structure-borne sound signal caused by a contact event or a damage event is recorded simultaneously at the three sensor elements of the sensor means. For further processing and evaluation the recorded analogue structure-borne sound signals may e.g. be converted by an analogue/digital converter into digital measurement signals. The digitised measurement signals may be forwarded to a computing unit and stored in a storage means so that the measurement signals, in particular the measurement signals of a certain time period, are available for further processing. A Fourier transform, in particular a short-time Fourier transform, is applied to at least one portion of the three measurement signals, respectively. The result of the short-time Fourier transform may be stored for further processing. In a further evaluation of the measurement signals respectively three phases of the individual frequency portions of the measurement signals are determined. Should any jumps of 2π occur, these can be separated out. Due to the dispersion the propagation speed of the structure-borne sound wave is frequency-dependent. This means that each frequency portion comprises its own propagation speed. Should a damage event or contact event occur, all frequency portions of the structure-borne sound wave at the site of impact are simultaneously stimulated. Based on these facts it is possible to determine, from the phase relation, in particular the phase difference of two frequency portions of a measurement signal at a sensor element, the runtime of the structure-borne sound signal between the sensor element and the site of impact. The runtime of the structure-borne sound signal can be used to determine the distance between the sensor element and the site of impact. The accuracy of the distance determination may be increased in that, for example, the runtimes of several frequency portions are determined, or in that a larger number of sensor elements is used.

In a preferred embodiment of the method at least one known wave speed, in particular a bending wave speed and/or a lamb wave speed and/or a longitudinal wave speed is input into the calculation of the distance between the sensor means and the site of impact. Preferably the method is used on motor vehicles, in particular the outer shell of motor vehicles. In the areal regions of the vehicle outer shell bending waves in particular propagate which are caused by a contact event or a damage event. The propagation speed of such a wave is frequency-dependent due to the dispersion. Different frequency portions of a wave comprise different propagation speeds. The frequency-dependent propagation speed of a bending wave, for example in a steel plate of a certain thickness, is known. Based on the known wave speed a length of run can be determined from the runtime of a frequency portion determined from the measurement signals.

In a further preferred embodiment of the method the phase difference of at least two measurement signals recorded at two different sensor elements is ascertained by forming the cross-power density and determining its phase, the runtime between the two sensor elements is determined using the phase difference of the measurement signals at two different sensor elements, the runtime differences of the runtimes are determined with a ratio being formed between the runtime differences of the sensor elements and conclusions being drawn from the ratio of the runtimes between the different sensor elements as to the direction from which the structure-borne sound signal has hit the sensor means. The direction from which the structure-borne sound signal caused by the contact or damage event hits the sensor means, can be determined by determining the runtimes between individual sensor elements of the sensor means. The ascertained direction of the structure-borne sound signal can, for example, be specified by giving angle details in the form of polar coordinates, Cartesian coordinates or other coordinate systems. The signal runtime between two sensor elements is ascertained via a phase determination of the signals. To this end the cross-power density of two measurement signals recorded at two sensor elements is formed and the phase of the cross-power density is determined. Any jumps of 2π can be separated out from the phase of the cross-power density and the phase can be tailored to a relevant range of frequency portions. From the thus determined phase difference of the frequency portions of the two measurement signals can be calculated a runtime of the measurement signal between the sensor elements. The runtimes of the measurement signals between all three sensor elements among each other are ascertained in the same way. The differences, i.e. the runtime differences, are determined from the runtimes of the measurement signals between the sensor elements. By forming the ratios of the runtime differences of the structure-borne sound signals between the different sensor elements, conclusions may be drawn as to the angle at which the structure-borne sound wave hits the sensor means. Due to the higher propagation speeds of structure-borne sound signal portions with higher frequencies the runtimes of the structure-borne sound signals between the sensor elements are smaller for higher frequencies than for lower frequencies. Thus it is preferable, due to measuring being easier, to form the ratios of the runtimes of the frequency portions with lower frequencies in order to determine the direction of the incoming structure-borne sound signals.

In an alternative embodiment of the method at least one cross correlation is formed from the measurement signals recorded at the at least two sensor elements, runtime differences of the measurement signals between the sensor elements are determined from the cross-correlation, a ratio is formed between the runtime differences and from the ratio of the runtime differences between the different sensor elements conclusions are drawn as to the direction from which the structure-borne sound signal has hit the sensor means. Due to determining the runtime differences of the measurement signals between the sensor elements conclusions can be drawn as to the direction from which the structure-borne sound signal has hit the sensor means. To this end a cross correlation can be formed between two measurement signals recorded by two different sensor elements. From the cross-correlation the runtime differences of the measurement signals between the sensor elements can be determined. With a sensor means with three different sensor elements for example three cross-correlations can be formed from the three recorded measurement signals. A ratio is formed between the runtime differences formed from the cross-correlation and from the ascertained ratio conclusions can be drawn as to the direction from which the registered signals have hit the sensor means. The direction of the measurement signal, i.e. of the structure-borne sound signal, may be depicted in the form of polar coordinates, Cartesian coordinates or in another coordinate system.

In a preferred embodiment of the method the recorded measurement signals are stored in at least one storage means, and the measurement signals which are stored first in the storage means, are the first to be read out of the storage means. Such storage means are known as First-in/First-out (FIFO) storage devices. The stored data is placed in a kind of queue so that it is ensured that the stored data is retrieved in the same sequence, in which they are stored.

In a further preferred embodiment of the method the stored measurement signals are examined for an exceedance of a threshold value in order to determine the respective start of the signal caused by the damage event or contact event. Determining the start of a structure-borne sound signal is important to further evaluation, since at the start of the structure-borne sound signal it is ensured that the signal portions are not overlaid by reflections of the structure-borne sound wave, for example at edge structures of the object to be examined such as the edges of a vehicle door. The start of a signal is determined by the exceedance of a threshold value such as an amplitude threshold value. The amplitude threshold value may lie just above the noise level.

In a further preferred embodiment of the method at least one portion of at least one measurement signal, in which an exceedance of the threshold value occurs, is moved into a position in the sequence of stored measurement signals in the storage means, which is identical to portions of other measurement signals in which also an exceedance of the threshold value occurs. For evaluation and comparability of the three measurement signals recorded by the three sensor elements these are shifted following their digitisation and storage in the storage means in such a way that the portion of the measurement signals, in which the threshold value was exceeded, lies in an identical congruent position, preferably in the middle of the sequence of the stored data in the storage means. A signal portion about this identical position may then be selected, for example, which is passed on for further evaluation and examination. For example a short-time Fourier transform may be performed at each of these three signal portions.

A further aspect of the invention relates to a device for detecting at least one structure-borne sound signal, in particular a structure-borne sound signal affected by a damage event and/or contact event, with at least one sensor means, wherein the sensor means comprises at least one signal-transferring connection with at least one storage means and at least one signal-transferring connection with at least one evaluation means. This device is characterised in particular in that the sensor means comprises at least two, in particular three, sensor elements for the mutually independent detection of at least one structure-borne sound signal, in that the sensor elements have a fixed spatial arrangement in relation to each other and in that the sensor means consists of a single structural unit only. Due to the fixed spatial arrangement of in particular three sensor elements it is possible, apart from determining the distance between the sensor means and the site of impact of the damage event and/or contact event, to determine the direction, from which the structure-borne sound signal hits the sensor means. The sensor elements, in their fixed spatial arrangement, are housed in a single structural unit. This is particularly advantageous for the assembly of the sensor means, as only one structural unit has to be mounted, for example to the inside of an areal component of the outer shell of the motor vehicle. There is thus no need for any cabling as is normally necessary with the assembly of individual sensor elements. This means a considerably reduction in terms of time spent on assembly. Furthermore a sensor means consisting of three sensor elements may be directly provided with an evaluation means which may e.g. also be housed in the structural unit. Where three individual sensor means are used, determination of the direction requires that the three evaluation means must be synchronised and that an additional communications interface must be provided between the three sensor means. By using a single sensor means with only one evaluation means there is then no need for these additional components and method steps.

In a preferred embodiment of the device the sensor elements are arranged on a common carrier part. By arranging the sensor elements of the sensor means on a common carrier part such as a film portion or a circuit board, the fixed spatial arrangement of the sensor elements in relation to each other is easily implemented.

With a particularly preferred development of the device, the sensor elements are arranged relative to each other in such a way that they form an equilateral triangle. The sensor elements are geometrically arranged at the corners of an equilateral triangle. For example the sensor elements may comprise symmetry axes which intersect in one point. The external angle between two symmetry axes of two adjacent sensor elements may be 120°, respectively. This arrangement makes it particularly easy to determine the direction of the incident structure-borne sound signal based on runtime differences of the structure-borne sound signal between the individual sensor elements.

In a further preferred development of the invention the carrier part is a film portion and the sensor elements are applied to this film portion by printing them on. For example, the film portion may consist of a thermoplastic material such as polyvinylidene fluoride (PVDF) or a similar plastic. When using a film as a carrier part, it is particularly advantageous that films can mostly be manufactured at very low cost, can be easily processed and, due to their flexibility, can be easily adapted to the existing space. The sensor elements and the conductor tracks required for connecting them to an evaluation unit are printed onto the film material using e.g. conductive ink or another conductive substance. For example several electrode layers may be printed onto the film, wherein overlapping areas of the electrode layers may form the active areas, i.e. the sensor elements. The sensor elements may be piezo-electric structure-borne sound receivers. Furthermore the film portion may comprise a power strip for the signal-transferring connection with e.g. an evaluation means.

In a further development of the invention the sensor elements arranged on the carrier part and the evaluation means are arranged in a common housing. Due to the arrangement of the evaluation means and the sensor elements the sensor means is easy to assemble. The housing protects the evaluation means and the sensor elements against external influences.

Furthermore the invention relates to a vehicle, in particular a motor vehicle, with a device according to one of claims 9 to 13. Devices according to the invention may, for example, be assembled to areal insides of the outer shell of the vehicle. This makes it possible to detect damage events and contact events at all important components of the vehicle.

### BRIEF DESCRIPTION OF THE DRAWINGS

The invention will now be explained in detail with reference to an embodiment shown in the drawing. In the schematically drawn diagrams

FIG. 1 shows a sensor means with three sensor elements on a carrier part in a top view,

FIG. 2a shows a sensor means and an evaluation means in a housing in a perspective view,

FIG. 2b shows a sensor means in a housing in the opened state,

FIG. 3 shows an exemplary arrangement of a sensor means and the distance between the site of impact and the sensor means as well as the direction of the incoming structure-borne sound signal,

FIG. 4 shows a diagram of elected method steps of the method for recording the structure-borne sound signals and their further processing.

### DETAILED DESCRIPTION OF THE PREFERRED EMBODIMENTS

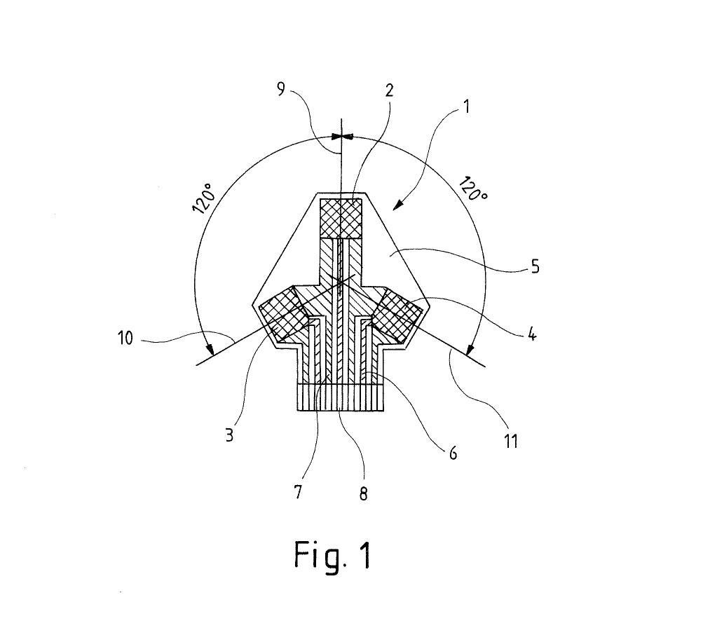

FIG. 1 shows a sensor means 1 with three sensor elements 2, 3, on a carrier part 5. The carrier part 5 consists of a PVDF film. Electrode layers 6, 7 have been applied to the carrier part 5, and their overlapping regions form the sensor elements 2, 3, 4. The three-channel sensor means 1 comprises a plug-in connection 8 for connection with e.g. an evaluation means. The symmetry axes 9, 10, 11 of the sensor elements 2, 3, 4 meet in a centre and the symmetry axes 9, 10, 11 of two adjacent sensor elements 2, 3, 4 comprise an angle of 120°.

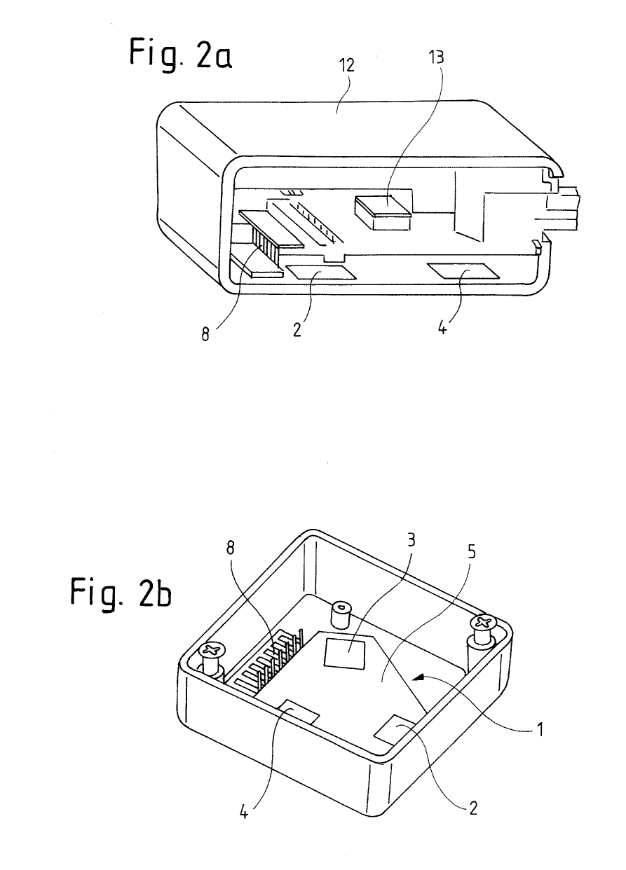

FIG. 2a shows a housing 12 with a sensor means 1 in the opened state. Due to the housing the sensor means 1 is protected against external influences.

FIG. 2b shows a housing 12 in the closed state with a sensor means 1 arranged therein and an evaluation means 13 connected with the sensor means. Due to the arrangement in a housing 12 the evaluation means 13 and the sensor means 1 form a fixed structural unit thereby permitting a simple assembly. Furthermore the housing 12 protects the sensitive sensor means 1 and the evaluation means 13 against external influences.

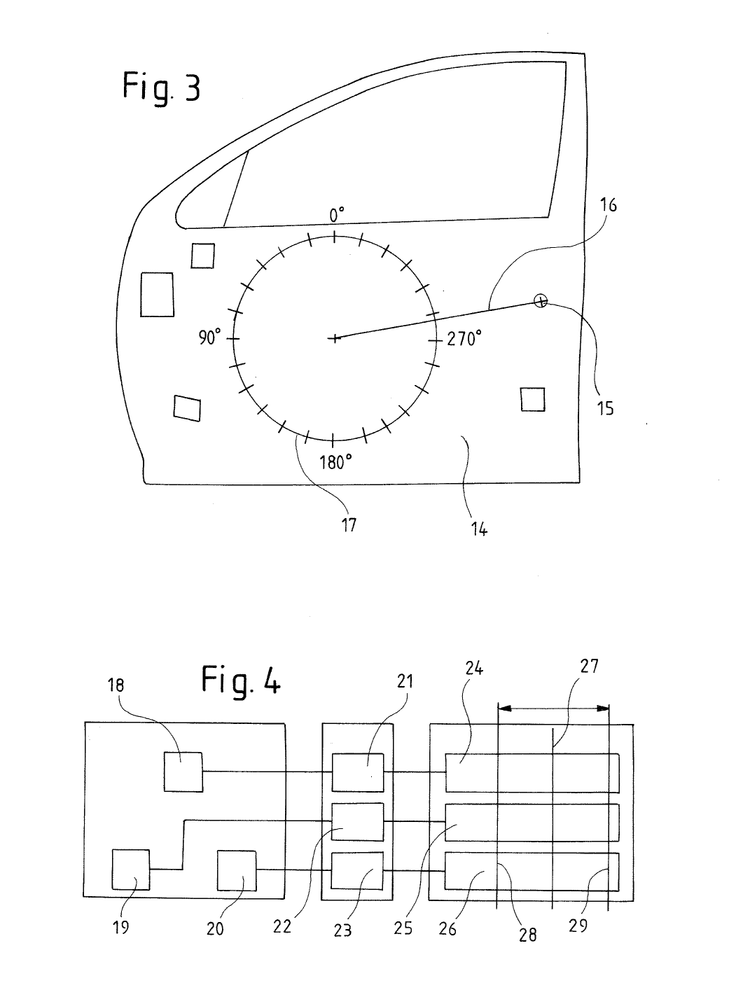

FIG. 3 shows the arrangement of a sensor means 1 using a motor vehicle door 14 as an example. The sensor means 1 is in a central position of the areal region of the motor vehicle door 14. A site of impact 15 of a damage or a contact event is indicated as an example. The distance 16 between the sensor means 1 and the site of impact 15 can be ascertained by determining the phase of a structure-borne sound signal. As an indication of the direction from which the structure-borne sound signal hits the sensor means 1 at the site of impact 15, a coordinate system 17 is shown, the origin of which is the position of the sensor means. The position of the site of impact is unequivocally defined by the indications of the angle and the distance.

FIG. 4 shows a schematic sequence of a selection of method steps. Measurement signals 18, 19, 20 are recorded at the sensor elements, independently of each other. The recorded analogue measurement signals 18, 19, 20 are converted into digital measurement signals 21, 22, 23 by an analogue/digital converter. The digital measurement signals 21, 22, 23 are stored respectively in a FIFO storage means. In the storage means the measurement signals 24, 25, 26 are shifted such that the signal portions 27, in which a threshold value is exceeded, are arranged identically, congruently within the sequence of data in the storage means. Around the signal portions in which a threshold is exceeded, a signal section with a forward limit 28 and a rearward limit 29 is selected. This signal section is passed to further processing and evaluation.

All features mentioned in the above description and in the claims can be randomly selectively combined with the features of the independent claim. The disclosure of the invention is thus not limited to the described and claimed feature combinations, rather all feature combinations which are meaningful within the framework of the invention are to be considered as disclosed.

1. A method for detecting at least one structure-borne sound signal, in particular for detecting at least one damage event and/or at least one contact event, in particular on a motor vehicle, with a sensor means,
wherein a site of impact of the damage event and/or contact event is determined by recording at least one measurement signal at a single sensor means consisting of only one structural unit, and by separately determining, on the one hand, the distance between the sensor means and the site of impact and, on the other, the direction from which the structure-borne sound signal hits the single sensor means.

2. The method according to claim 1, wherein the measurement signals of at least two, in particular three sensor elements of the sensor means are recorded.

3. The method according to claim 1, wherein a Fourier transform, in particular a short-time Fourier transform, is applied respectively to at least one portion of the measurement signal and thus the phases of individual frequency portions are determined, in that the phase difference of at least two frequency portions is determined in that the runtime of the structure-borne sound signal is calculated from the phase difference, and in that the distance between the sensor element and the site of impact is determined from the runtime of the structure-borne sound signal.

4. The method according to claim 3, wherein at least one known wave speed, in particular a bending wave speed and/or a lamb wave speed and/or a longitudinal wave speed is input into the calculation of the distance between the sensor means and the site of impact.

5. The method according to claim 2, wherein the phase difference of at least two measurement signals recorded at at least two different sensor elements is ascertained by forming the cross-power density and by determining its phase, in that the runtime of the measurement signals between the two sensor element is determined from the phase difference of the measurement signals at two different sensor elements, in that a ratio is formed of the runtime differences between the sensor elements and in that from the ratio of the runtime differences between the different sensor elements a conclusion is drawn regarding the direction from which the structure-borne sound signal has hit the sensor means.

6. The method according to claim 2, wherein at least one cross-correlation is formed from the measurement signals recorded at the at least two sensor elements, in that runtime differences of the measurement signals between the sensor elements are determined from the cross-correlation, in that a ratio is formed between the runtime differences and in that from the ratio of the runtime differences between the different sensor elements conclusions are drawn regarding the direction from which the structure-borne sound signal has hit the sensor means.

7. The method according to claim 1, wherein the recorded measurement signals are stored in at least one storage means and in that the measurement signals stored first in the storage means are the first to be read out from the storage means.

8. The method according to claim 7, wherein the measurement signals for determining the respective start of the measurement signal caused by the damage event or contact event is examined for exceedance of a threshold value.

9. The method according to claim 8, wherein at least one portion of at least one measurement signal in which a threshold exceedance occurs, is shifted into a position in the sequence of stored measurement signals in the storage means, which is identical to portions of other measurement signals in which a threshold exceedance also occurs.

10. A device for detecting at least one structure-borne sound signal, in particular of a structure-borne sound signal influenced by a damage event and/or contact event, with at least one sensor means, wherein the sensor means comprises at least one signal-transferring connection with at least one storage means and at least one signal-transferring connection with at least one evaluation means,
wherein the sensor means comprises at least two, in particular three sensor elements for detecting independently of each other, at least one structure-borne sound signal, the sensor elements have a fixed spatial arrangement in relation to each other, and the sensor means consists of a single structural unit.

11. The device according to claim 10, wherein the sensor elements are arranged on a common carrier part.

12. The device according to claim 10, wherein the sensor elements are arranged in the form of an equilateral triangle.

13. The device according to claim 11, wherein the carrier part is a film portion and in that the sensor elements are applied to this film portion by printing them on.

14. The device according to claim 13, wherein the sensor elements arranged on the carrier part and the evaluation means are arranged in a common housing.

15. A vehicle, in particular motor vehicle, with a device according to claim 10.
